(19) United States
(12) Patent Application Publication
(10) Pub. No.: US 2009/0132608 A1
(43) Pub. Date: May 21, 2009

(54) SYSTEM AND METHOD FOR DOCUMENT PROCESSING MAINTENANCE REPORTING

(76) Inventors: Brenda DAOS, Mission Viejo, CA (US); Marianne L. Kodimer, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/944,172

(22) Filed: Nov. 21, 2007

(51) Int. Cl. G06F 17/30

(52) U.S. Cl. 707/202; 707/E17.007

(57) ABSTRACT

The subject application is directed to a system and method for document processing maintenance reporting. First, a service operation of an associated document processing device is commenced. Next, data corresponding to the service operation on the document processing device is logged into an associated data storage after the commencement of the operation. Address data corresponding to the address of at least one system administrator assigned to the document processing device is then stored. The service operation is then concluded upon the completion of the operation. A report format instruction is then received after the completion of the service operation. Maintenance operation report data is then generated in accordance with the logged data. The generated maintenance operation report data is then selectively transmitted to the at least one system administrator in accordance with the stored address data and with the received report format instruction.

### BACKGROUND OF THE INVENTION

The subject application is directed generally to maintenance of devices, such as document processing devices. The application is particularly applicable to ensuring that a system administrator is notified relative to completion of a system maintenance operation by a technician.

Document processing devices include printers, copiers, and facsimile machines, as well as devices known as multifunction peripherals (MFPs), which have two or more of these functions. Document processing devices are complex, and require regular maintenance in order to remain in good working order. Such maintenance operations may include replacement of parts or consumables, making configuration changes, or upgrading of hardware of software. Often times an administrator is charged with overseeing one or more devices, such as might be expected in a networked office environment. There are occasions when maintenance operations are performed by individuals, other than an administrator. For example, a manufacturer or manufacturer representative may come on site for certain maintenance procedures. When an operation is completed, a technician may depart without having notified an administrator as to what changes occurred.

If an administrator is unaware as to what was completed during a maintenance operation he may not be prepared to address the changes that were made. Additionally, he may be disadvantaged in diagnosing any problems that may be attributed to the maintenance operation.

### SUMMARY OF THE INVENTION

In accordance with one embodiment of the subject application, there is provided a system and method directed to the maintenance of devices, such as document processing devices.

Further, in accordance with one embodiment of the subject application, there is provided a system and method applicable to ensuring that a system administrator is notified relative to completion of a system maintenance operation by a technician.

Still further, in accordance with one embodiment of the subject application, there is provided a system for document processing maintenance reporting. The system comprises means adapted for commencing a service operation of an associated document processing device and logging means adapted for logging data into an associated data storage corresponding to a service operation on the document processing device after commencement thereof. The system also comprises means adapted for storing address data corresponding to an address of at least one system administrator assigned to the document processing device, means adapted for concluding a service operation upon completion thereof, and means adapted for receiving a report format instruction after completion of a service operation. The system further comprises means adapted for generating maintenance operation report data in accordance with logged data and means adapted for selectively transmitting generated maintenance operation report data to the at least one system administrator in accordance with stored address data and in accordance with a received report format instruction.

In one embodiment of the subject application, the system also comprises means adapted for generating a tangible printout of the maintenance operation report data in accordance with a received report format instruction.

In another embodiment of the subject application, the system further comprises means adapted for generating an animated user interface session corresponding to a completed service operation.

In a further embodiment of the subject application, the maintenance operation report data includes data corresponding to a timing of a service operation.

In still another embodiment of the subject application, the system also includes means adapted for receiving login data prior to commencement of a service operation. The login data includes data corresponding to an identity of a technician performing a service operation, and the identity of the technician is reflected in the maintenance operation report data.

In yet another embodiment of the subject application, the system further includes means adapted for capturing error code data associated with operation of the document processing device, and wherein the error code data is reflected in the maintenance operation report data.

Still further, in accordance with one embodiment of the subject application, there is provided a method for document processing maintenance reporting in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for document processing maintenance reporting according to one embodiment of the subject application;

FIG. 2 is a block diagram illustrating device hardware for use in the system for document processing maintenance reporting according to one embodiment of the subject application;

FIG. 3 is a functional diagram illustrating the device for use in the system for document processing maintenance reporting according to one embodiment of the subject application;

FIG. 4 is a block diagram illustrating controller hardware for use in the system for document processing maintenance reporting according to one embodiment of the subject application;

FIG. 5 is a functional diagram illustrating the controller for use in the system for document processing maintenance reporting according to one embodiment of the subject application;

FIG. 6 is a flowchart illustrating a method for document processing maintenance reporting according to one embodiment of the subject application; and

FIG. 7 is a flowchart illustrating a method for document processing maintenance reporting according to one embodiment of the subject application.

### DETAILED DESCRIPTION OF THE PREFERRED EMBODIMENT

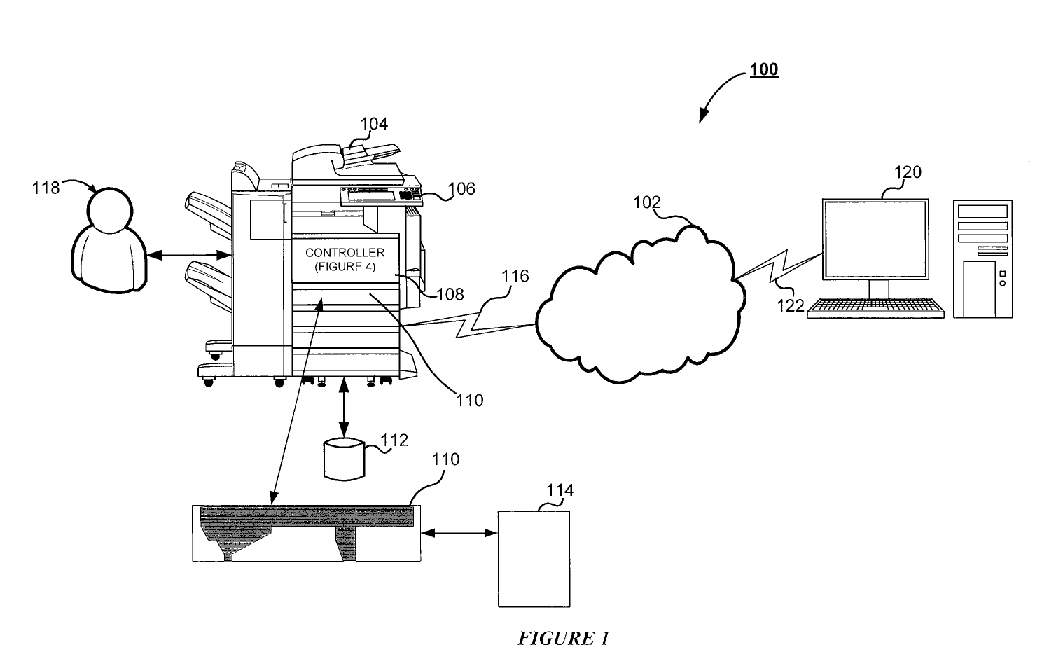

The subject application is directed to a system and method for the maintenance of devices. In particular, the subject application is directed to a system and method for document processing maintenance reporting. More particularly, the subject application is directed to a system and method applicable to ensuring that a system administrator is notified relative to completion of a system maintenance operation by a technician. It will become apparent to those skilled in the art that the system and method described herein are suitably adapted to a plurality of varying electronic fields employing log generation, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for document processing maintenance reporting in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

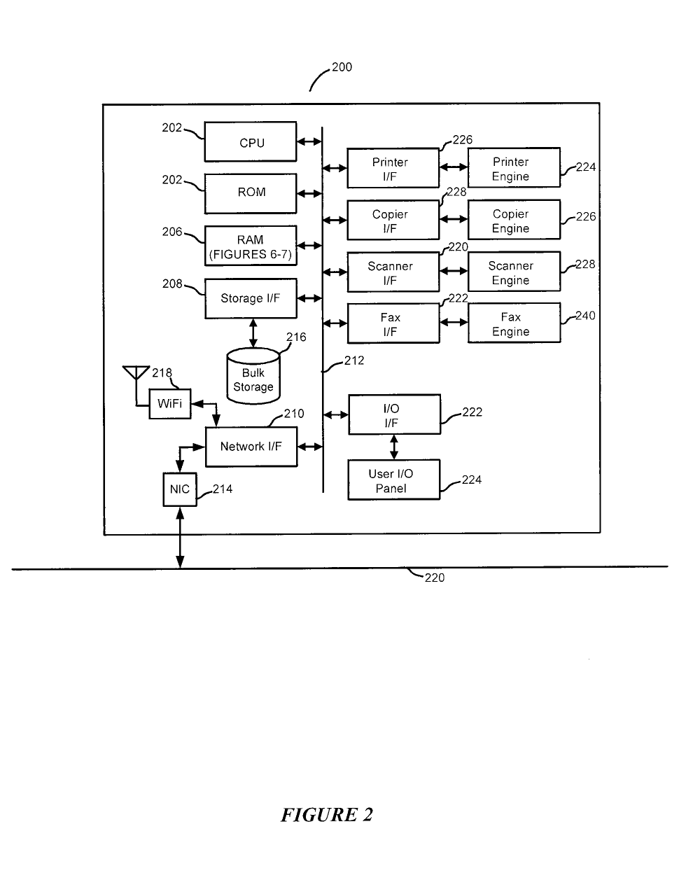

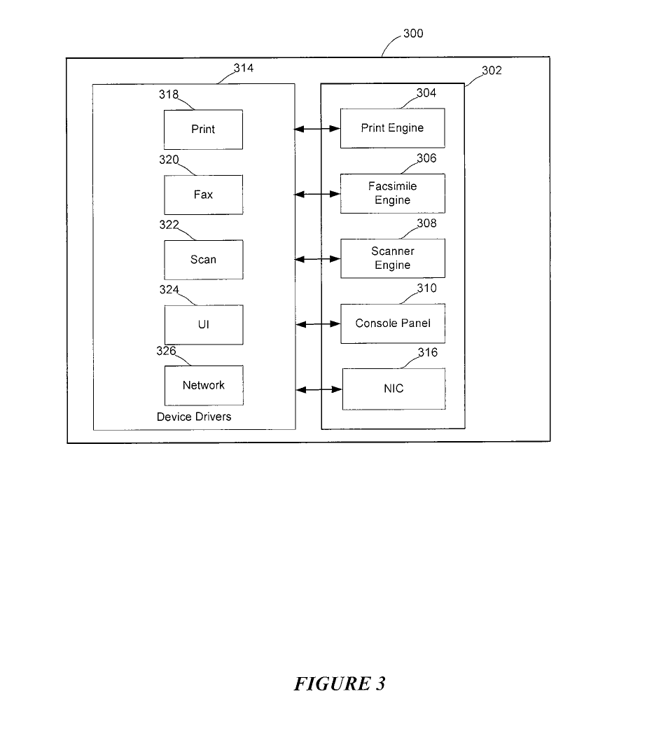

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 116. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

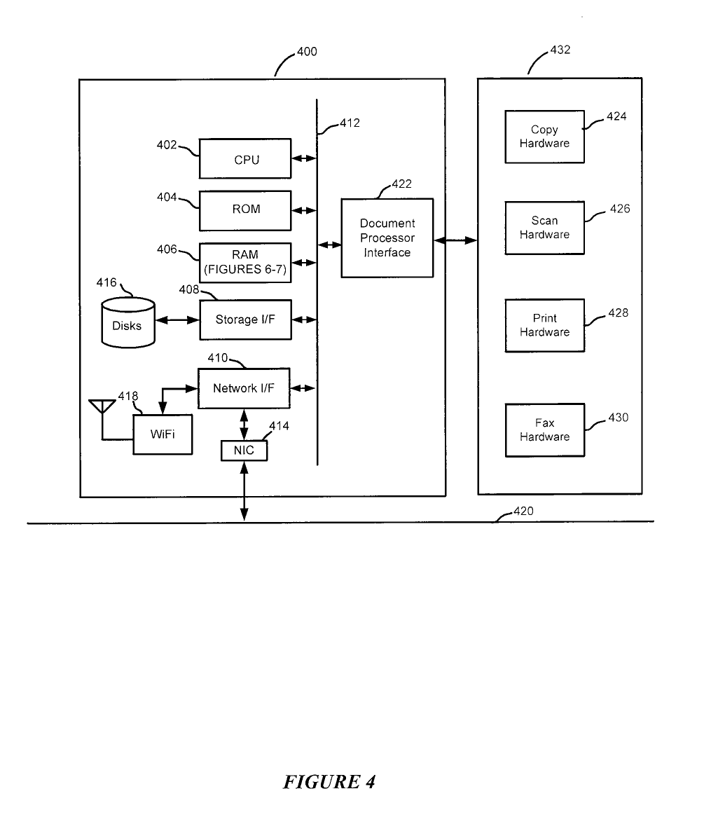

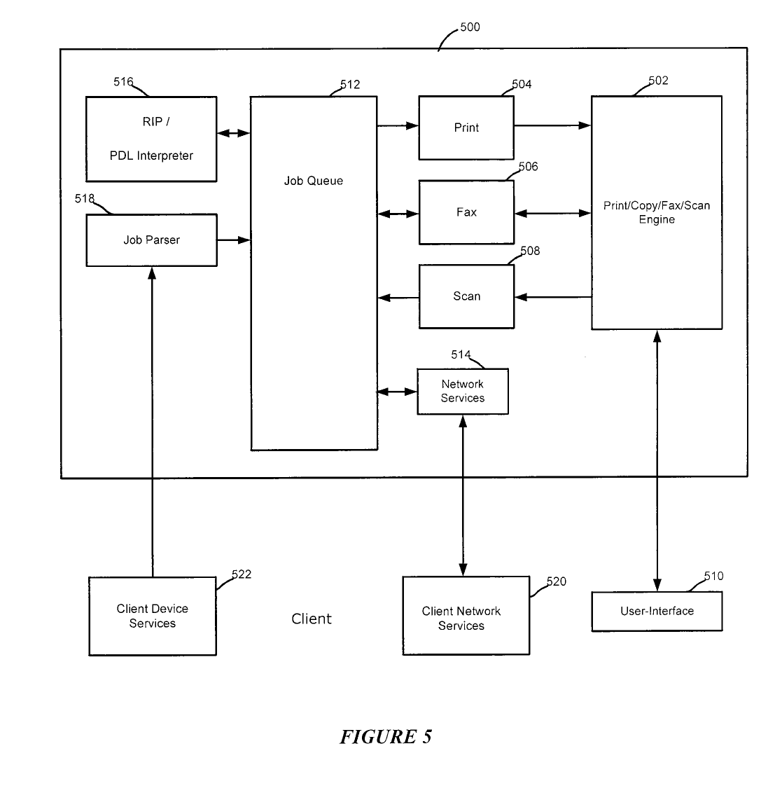

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for document processing maintenance reporting of the subject application. The functioning of the controller 108 will better be understood in conjunction with the block diagrams illustrated in FIGS. 4 and 5, explained in greater detail below.

Communicatively coupled to the document processing device 104 is a data storage device 112. In accordance with the preferred embodiment of the subject application, the data storage device 112 is any mass storage devices known in the art including, for example and without limitation, magnetic storage drives, a hard disk drive, optical storage devices, flash memory devices, or any suitable combination thereof. In the preferred embodiment, the data storage device 112 is suitably adapted to store document data, maintenance reports, administrative contact information, image data, electronic database data, or the like. It will be appreciated by those skilled in the art that while illustrated in FIG. 1 as being a separate component of the system 100, the data storage device 112 is capable of being implemented as an internal storage component of the associated document processing device 104, a component of the controller 108, or the like, such as, for example and without limitation, an internal hard disk drive, or the like.

As depicted in FIG. 1, the document processing device 104 further includes one or more media storage trays 110, suitably configured to stored output media 114 for output by the document processing device 110. The skilled artisan will appreciate that the media storage tray 110 is representative of any of a myriad of storage components associated with the document processing device 104 capable of storing sheets of paper of varying sizes, sheets of transparencies, blank reporting forms, blank greeting cards, blank multi-media, blank CD or DVD media, blank business cards, blank perforated media, photographic paper, envelopes, or any other tangible output medium upon which documents or images are rendered.

The system 100 illustrated in FIG. 1 further depicts an administrative device 120, in data communication with the computer network 102 via a communications link 122. It will be appreciated by those skilled in the art that the administrative device 120 is shown in FIG. 1 as a computer workstation for illustration purposes only. As will be understood by those skilled in the art, the administrative device 120 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 120 is suitably adapted to transmit and receive electronic documents, multimedia files, document processing instructions, user interface modifications, upgrades, updates, personalization data, or the like, to and from the document processing device 104, or any other similar device coupled to the computer network 102. In accordance with one embodiment of the subject application, the administrative device 120 includes a thin client interface, such as a web browser application, suitably adapted to securely interact with the document processing device 104 or the like.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by the processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which include the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a job parser 518, which job parser suitably functions to receive print job language files from an external device, such as client device services 522. The client device services 522 suitably include printing, facsimile transmission, or other suitable input of an electronic document for which handling by the controller function 500 is advantageous. The job parser 518 functions to interpret a received electronic document file and relay it to the job queue 512 for handling in connection with the afore-described functionality and components.

In operation, a service operation of an associated document processing device is first commenced. Data is then logged into an associated data storage corresponding to the service operation on the document processing device after the commencement of the operation. Address data is then stored corresponding to the address of at least one system administrator assigned to the document processing device. The service operation is then concluded upon the completion of the operation. A report format instruction is then received after the completion of the service operation. Maintenance operation report data is thereafter generated in accordance with the logged data. The generated maintenance operation report data is then selectively transmitted to the at least one system administrator in accordance with the stored address data and with the received report format instruction.

In accordance with one example embodiment of the subject application, login data is received from an associated technician 118 corresponding to an identity associated with the technician 118. It will be understood by those skilled in the art that such login data includes, for example and without limitation, a username and/or password, biometric data, name, position, employer, department, or the like. The technician 118 then commences a service operation on the document processing device 104. Data associated with the service operation is then logged by the controller 108 or other suitable component associated with the document processing device 104. According to one embodiment of the subject application, the service logging includes screen captures of technician interaction with the user interface 106, event capture with associated date/time stamp, and the like. Error code data corresponding to an error associated with an operation of the document processing device 104 is then captured by the controller 108 or other suitable component associated with the document processing device 104.

Upon conclusion of the service operation performed by the technician 118, an animated user interface session corresponding to the service operation is generated by the controller 108 or other suitable component associated with the document processing device 104. It will be appreciated by those skilled in the art that the animated user interface session includes, for example and without limitation, captured screen images associated with the technician 118 interaction with the document processing device 104 to correct an error, perform an upgrade, perform the service, and the like.

A report format instruction associated with the document processing device 104 is then received corresponding to a format on the reporting of the service operation to a system administrator, authorized user, service provider, or the like. It will be understood by those skilled in the art that the received report format instruction corresponds to the type of information regarding the service operation such as, for example and without limitation, technician identification, date/time stamp for completion, date/time stamp for work-in-progress, free form text input from the technician 118, technician contact information, error codes initiating service operation, type of communication of report, notification requirements, and the like. In accordance with one example embodiment of the subject application, the instructions originate via interaction with the technician 118 via the user interface 106, preselected by a system administrator associated with the document processing device 104, and the like.

The controller 108 or other suitable component associated with the document processing device 104 then analyzes the received report format instructions so as to determine the data to be included in maintenance operation data from the log data, the form of communication the report is to take, e.g. electronic communication, hardcopy output, storage location for web access, and the like. A maintenance operation report is then generated by the controller 108 or other suitable component associated with the document processing device 104 from the log data in accordance with the analyzed report format instructions. The skilled artisan will appreciate that such maintenance report is capable of including, for example and without limitation, the error code data, technician information, the animated user interface session, date/time information, services performed, consumables replaced, resources renewed, and the like.

When electronic communication of the maintenance report is indicated by the received report format instruction, an address, such as an IP address, electronic mail address, http address, or the like, corresponding to at least one administrator associated with the document processing device 104 is then received by the controller 108 or other suitable component associated with the document processing device 104. It will be appreciated by those skilled in the art that such address data is capable of being received from the technician 118 via interactions with the user interface 106 associated with the document processing device 104, previously stored in the data storage device 110 or system memory associated with the document processing device 104, and the like. The generated maintenance report is then selectively transmitted to the administrator from the controller 108 or other suitable component associated with the document processing device 104. For example, when the address data associated with the report format instruction, input by the technician 118, stored on the data storage device 110, or the like, indicates an electronic mail address, the controller 108 communicates an electronic mail message, with the maintenance report attached thereto, to the designated address. In accordance with another example embodiment, when the address data corresponds to an IP address, such as the IP address associated with the administrative device 120, the controller 108 communicates the maintenance report to the administrative device 120 via the computer network 102, as will be understood by those skilled in the art. A determination is then made, following such communication, whether the report format instruction also indicates the generation of a hardcopy output.

When the report format instruction indicates that a hardcopy output is desired in addition to the electronic communication, or in place thereof, the document processing device 104, via control of the controller 108, generates a tangible printout of the maintenance report, using the tangible output media 114 stored in the storage tray 110 associated with the document processing device 104. It will be appreciated by those skilled in the art that such tangible printout of any animated user interface session corresponding to the service operation of the maintenance report is output as a series of screen capture images on the tangible output media 114.

In the event that storage for later retrieval by an administrator associated with the document processing device 104 is dictated by the received report format instruction, in addition to or in place of the electronic communication and/or hardcopy output, the controller 108 or other suitable component associated with the document processing device 104 facilitates the storage of the generated maintenance report at the designated storage location. The skilled artisan will appreciate that the maintenance report is capable of being stored following communication to the administrator and/or following hardcopy output, depending upon the received report format instruction, For example, when the designated storage location is the data storage device 110 associated with the document processing device 104, the controller 108 selectively communicates the maintenance report to the data storage device 110 for storage thereon. It will be appreciated by those skilled in the art that the designated storage location is capable of corresponding to any suitable storage device coupled to the computer network 102 with which the document processing device 104 is capable of communication. Thus, as will be understood by the skilled artisan, the maintenance report is thereby viewable and/or accessible by an administrator via the user interface 106 associated with the document processing device 104, via the administrative device 120 via a suitable thin client interface with the document processing device 104, via the administrative device 120 via a suitable thin client interface with the network storage location (not shown), or the like.

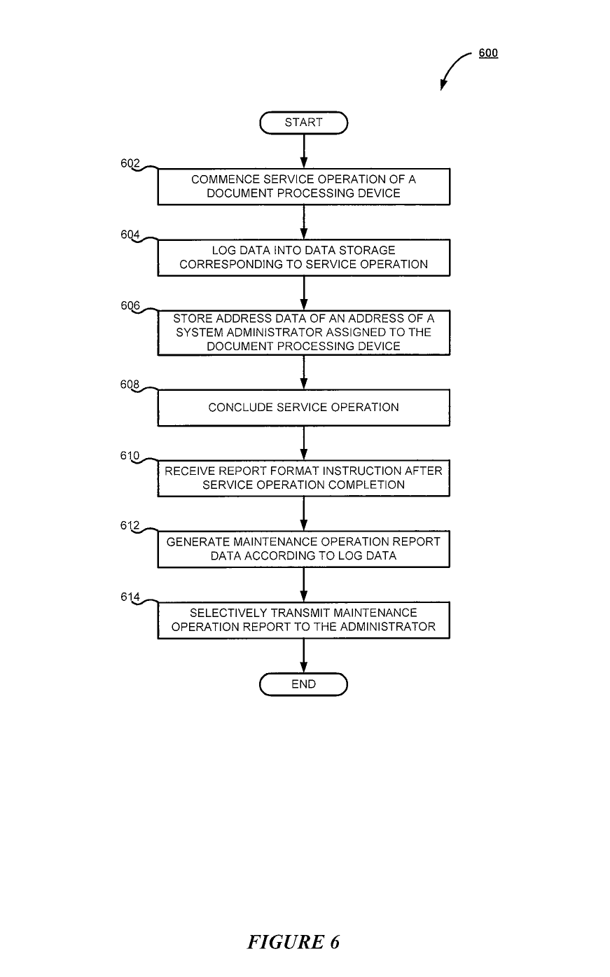

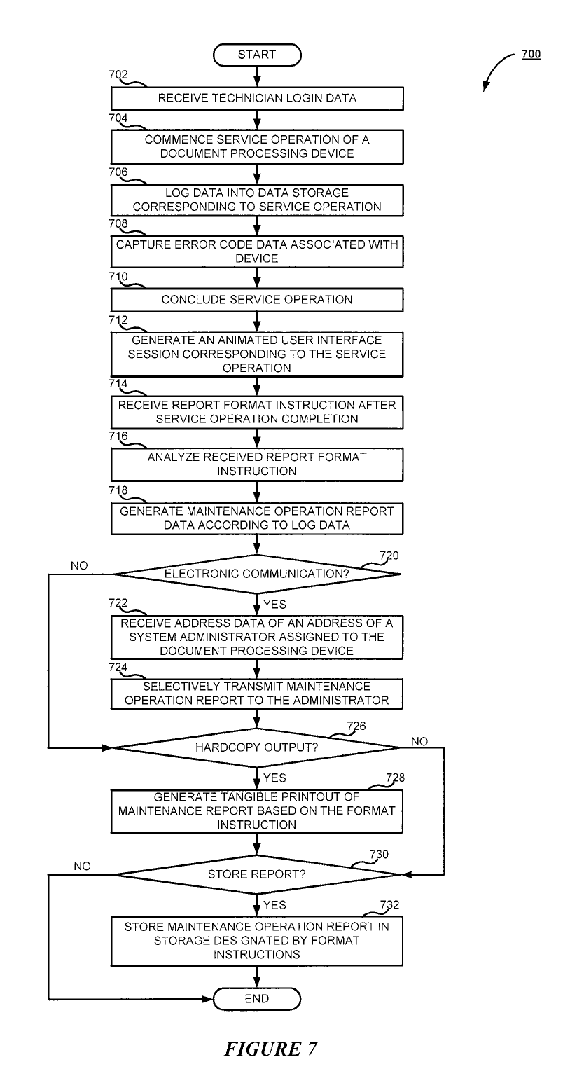

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for document processing maintenance reporting in accordance with one embodiment of the subject application. Beginning at step 602, a service operation is commenced of the document processing device 104 by an associated service technician 118. It will be appreciated by those skilled in the art that such service operation is capable of being undertaken by the technician via interactions with the user interface 106, remotely via a portable computing device (not shown), or the like. According to one embodiment of the subject application, the initiation of a service operation corresponds to the logon of the technician, the entry of a service code, or the like.

At step 604, data is logged into the data storage device 110 associated with the document processing device 104 corresponding to the service operation commenced on the document processing device 104. Address data is then stored at step 606 corresponding to the address of at least one system administrator assigned to the document processing device 104. It will be appreciated by those skilled in the art that the address data is capable of being input by the technician 118 via the user interface 106 and is capable of corresponding to an electronic mail address associated with the administrator, an IP address associated with the administrative device 120, or the like. At step 608, the service operation is then concluded upon the completion of the operation.

The controller 108 or other suitable component associated with the document processing device 104 then receives a report format instruction following the completion of the service operation at step 610. It will be appreciated by those skilled in the art that the report format instruction includes commands, data, and the like, corresponding to the type of information from the log data to include in a maintenance operation report. At step 612, the controller 108 or other suitable component associated with the document processing device 104 then generates a maintenance operation report in accordance with the logged data. The generated maintenance operation report data is then selectively transmitted at step 614 to the at least one system administrator in accordance with the stored address data and with the received report format instruction.

Referring now to FIG. 7, there is shown a flowchart 700 illustrating a method for document processing maintenance reporting in accordance with one embodiment of the subject application. The methodology of FIG. 7 begins at step 702, whereupon login data is received from a technician 118 associated with a service operation to be performed on an associated document processing device 104. Preferably, the login data received from the technician 118 enables the identification of the name of the technician 118, position, department, employer, contact data, and the like. In accordance with one embodiment of the subject application, the login data is received as, for example and without limitation, a username and/or password, biometric data, smart card data, or the like, which is associated with such technician 118, as will be understood by those skilled in the art.

At step 704, a service operation on the document processing device 104 is then commenced by the technician. The controller 108 or other suitable component associated with the document processing device 104, at step 706, logs data associated with the service operation into the data storage device 110 or system memory associated with the document processing device 104. It will be appreciated by those skilled in the art that the service logging includes, for example and without limitation, screen capture of the interactions of the technician 118 and the user interface 106, event capture of services provided, date/time stamp of services provided, and the like. At step 708, error code data associated with operations of the document processing device 104 is then captured by the controller 108 or other suitable component associated with the document processing device 104 and stored with the log data. The service operation is then concluded at step 710 upon the completion of the services provided by the associated technician 118.

At step 712, an animated user interface session corresponding to the service operation performed by the technician is then generated by the controller 108 or other suitable component associated with the document processing device 104. It will be appreciated by those skilled in the art that such animated session corresponds to captured screens that were displayed to the technician 118 and the inputs provided by the technician via the user interface 106. Thus, as will be understood by those skilled in the art, an animated sequence of screen shots is generated and stored on the associated data storage device 110. It will be appreciated by those skilled in the art that the animated user interface session includes, for example and without limitation, captured screen images associated with the interaction of the technician 118 with the document processing device 104 to correct a error, perform an upgrade, perform the service, and the like.

A report format instruction associated with the document processing device 104 is then received at step 714 corresponding to a format on the reporting of the service operation to a system administrator, authorized user, service provider, or the like. In accordance with one embodiment of the subject application, the received instruction represents the type of information in the log data to be reported out, the type of communication to the system administrator notifying the administrator of the information, and the like. Preferably, the report format instruction further includes, for example and without limitation, technician identification, date/time stamp for completion, date/time stamp for work-in-progress, free form text input from the technician 118, technician contact information, error codes initiating service operation, notification requirements, and the like. In accordance with one example embodiment of the subject application, the instructions originate via interaction with the technician 118 via the user interface 106, preselected by a system administrator associated with the document processing device 104, and the like.

At step 716, the received report format instruction is analyzed by the controller 108 or other suitable component associated with the document processing device 104. Based upon this analysis, a maintenance operation report is then generated from the log data stored on the data storage device 110 or system memory by the controller 108 or other suitable component associated with the document processing device 104. In accordance with one example embodiment of the subject application, the maintenance report includes, for example and without limitation, the error code data, technician information, the animated user interface session, date/time information, services performed, consumables replaced, resources renewed, and the like.

A determination is then made, based upon the received report format instruction, whether electronic communication of the generated maintenance report is desired at step 720. When electronic communication of the maintenance report is indicated by the received report format instruction, flow proceeds to step 722. At step 722, the controller 108 or other suitable component associated with the document processing device 104 receives an address, such as an IP address, electronic mail address, http address, or the like, corresponding to at least one administrator associated with the document processing device 104. The skilled artisan will appreciate that such address data is capable of being received from the technician 118 via interactions with the user interface 106 associated with the document processing device 104, previously stored in the data storage device 110 or system memory associated with the document processing device 104, or the like. Flow then progresses to step 724, whereupon the generated maintenance report is selectively transmitted to the administrator by the controller 108 or other suitable component associated with the document processing device 104. Thus, when an electronic mail address is included in the report format instruction, the controller 108 or other suitable component associated with the document processing device 104 communicates the generated maintenance report to the mail address associated with the administrator. For example, an electronic mail message is communicated to the designated electronic mail address with the maintenance report attached.

Following communication of the maintenance report to the designated address, or upon a negative determination at step 720, flow proceeds to step 726, whereupon a determination is made whether the report format instruction indicates that a hardcopy output is desired. When it is determined at step 726 that a hardcopy output is requested in accordance with the received report format instruction, operations of the controller 108 or other suitable component associated with the document processing device 104 progresses to step 728. At step 728, the document processing device 104, via control of the controller 108, generates a tangible printout of the maintenance report, using the tangible output media 114 stored in the storage tray 110 associated with the document processing device 104. In accordance with such a determination, the skilled artisan will appreciate that such a tangible printout of any animated user interface session associated with the maintenance report is output as a series of screen capture images on the tangible output media 114.

Following generation of the tangible output at step 728, or upon a determination at step 726 that a tangible hardcopy output is not indicated by the received report format instruction, flow proceeds to step 730, whereupon a determination is made whether the report format instruction dictates the storage of the maintenance report. Upon a negative determination at step 730, the methodology of FIG. 7 thereafter terminates. When storage is indicated by the received report format instruction, flow proceeds to step 732, whereupon the maintenance operation report is stored in the storage designated by the report format instruction. For example, when instruction indicates that the maintenance report is to be stored for later retrieval by an administrator associated with the document processing device 104, the maintenance report is communicated to the data storage device 110 or any other suitable network storage (not shown) for storage thereon. In accordance with such an embodiment of the subject application, the skilled artisan will appreciate that the foregoing thereby enables the administrator to view the maintenance report via the user interface 106 associated with the document processing device 104, via the administrative device 120 via a suitable thin client interface with the document processing device 104, via the administrative device 120 via a suitable thin client interface with the network storage location (not shown), or the like.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing maintenance reporting system comprising:
means adapted for commencing a service operation of an associated document processing device;
logging means adapted for logging data into an associated data storage corresponding to a service operation on the document processing device after commencement thereof;
means adapted for storing address data corresponding to an address of at least one system administrator assigned to the document processing device;
means adapted for concluding a service operation upon completion thereof;
means adapted for receiving a report format instruction after completion of a service operation;
means adapted for generating maintenance operation report data in accordance with logged data; and
means adapted for selectively transmitting generated maintenance operation report data to the at least one system administrator in accordance with stored address data and in accordance with a received report format instruction.

2. The system of claim 1 further comprising means adapted for generating a tangible printout of the maintenance operation report data in accordance with a received report format instruction.

3. The system of claim 1 further comprising means adapted for generating an animated user interface session corresponding to a completed service operation.

4. The system of claim 1 wherein the maintenance operation report data includes data corresponding to a timing of a service operation.

5. The system of claim 1 further comprising means adapted for receiving login data prior to commencement of a service operation, the login data including data corresponding to an identity of a technician performing a service operation, and wherein the identity of the technician is reflected in the maintenance operation report data.

6. The system of claim 1 further comprising means adapted for capturing error code data associated with operation of the document processing device, and wherein the error code data is reflected in the maintenance operation report data.

7. A document processing maintenance reporting method comprising the steps of:
commencing a service operation of an associated document processing device;
logging data into an associated data storage corresponding to a service operation on the document processing device after commencement thereof;
storing address data corresponding to an address of at least one system administrator assigned to the document processing device;
concluding a service operation upon completion thereof;
receiving a report format instruction after completion of a service operation;
generating maintenance operation report data in accordance with logged data; and
selectively transmitting generated maintenance operation report data to the at least one system administrator in accordance with stored address data and in accordance with a received report format instruction.

8. The method of claim 7 further comprising the step of generating a tangible printout of the maintenance operation report data in accordance with a received report format instruction.

9. The method of claim 7 further comprising the step of generating an animated user interface session corresponding to a completed service operation.

10. The method of claim 7 wherein the maintenance operation report data includes data corresponding to a timing of a service operation.

11. The method of claim 7 further comprising the step of receiving login data prior to commencement of a service operation, the login data including data corresponding to an identity of a technician performing a service operation, and wherein the identity of the technician is reflected in the maintenance operation report data.

12. The method of claim 7 further comprising the step of capturing error code data associated with operation of the document processing device, and wherein the error code data is reflected in the maintenance operation report data.
